(19) United States
(12) Patent Application Publication
(10) Pub. No.: US 2022/0192205 A1
(43) Pub. Date: Jun. 23, 2022

(54) FUNCTIONAL WELL-BEING PIZZA DOUGH AND PIZZA

(71) Applicant: Young Jon LEE, Seoul (KR)

(72) Inventor: Young Jon LEE, Seoul (KR)

(21) Appl. No.: 17/549,268

(22) Filed: Dec. 13, 2021

(30) Foreign Application Priority Data
Dec. 18, 2020 (KR) 10-2020-0178704

(51) Int. Cl. A21D 2/36; A21D 2/18; A21D 2/16; A21D 2/26; A21D 8/04; A21D 2/02; A21D 13/41

(52) U.S. Cl. CPC A21D 2/36; A21D 2/181; A21D 2/165; A21D 13/41; A21D 8/047; A21D 2/02; A21D 2/263

(57) ABSTRACT

Provided is functional well-being pizza dough and a pizza prepared by using the same, which is digestible and increases savor and flavor by containing a great deal of fiber. The functional well-being pizza dough manufactured using dough mixed of 2,750 to 2,800 parts by weight of wheat flour, 1,300 to 1,400 parts by weight of water, 110 to 120 parts by weight of refined sugar, 70 to 80 parts by weight of soybean oil, 80 to 90 parts by weight of grain-nut mixture, 50 to 60 parts by weight of refined salt, 20 to 30 parts by weight of whey powder, 8 to 12 parts by weight of bread improver, 4 to 6 parts by weight of sourdough, 4 to 6 parts by weight of yeast, 2 to 4 parts by weight of chlorella powder, and 1 to 4 parts by weight of green tea powder.

### CROSS-REFERENCE TO RELATED APPLICATION(S)

This application claims priority under 35 USC 119 to Korean patent application No. 10-2020-0178704 filed on Dec. 18, 2020, the contents of which is hereby incorporated by reference.

### BACKGROUND OF THE INVENTION

### Field of the Invention

The present invention relates to pizza dough and a pizza prepared by using the same and, more specifically, to functional well-being pizza dough and pizza, which is digestible and increases savor and flavor by containing a great deal of fiber, and can promote health by evenly containing nutrients.

### Background Art

In general, pizza is food manufactured through the steps of: mixing wheat flour, yeast, milk, and a plurality of additives, kneading the mixture, and aging the mixture to make pizza dough; spreading the pizza dough; putting cheese, vegetables, meat, sauce, or other minor ingredients on the spread pizza dough; and roasting the ingredients for pizza in a frying pan, an oven or the like.

With a change in dietary life, the pizza is widely used as a meal substitute since people can eat conveniently and the pizza contains enough calories.

However, the pizza and the pizza dough, which is a raw material for manufacturing pizza, have several disadvantages in that they may cause obesity or adult diseases due to a high calorie content because of cheese or milk, may run counter to well-being food which emphasizes naturalism and is to maintain healthy body and mind, and are inadequate as healthy food.

In addition, the conventional pizza and pizza dough have several disadvantages in that they are indigestible due to a low digestibility, and in that they lack nutrients and do not have many elements which are help for physical activities. Recently, pizza with sufficient nutrients is produced by adding various kinds of topping and cheese, but is indigestible due to lots of wheat flour contained in the pizza dough and is still not recognized as healthy food due to high calorie materials, such as the topping and cheese added to the pizza dough.

Moreover, since gluten contained in wheat causes a celiac disease, wheat allergy, and gluten hypersensitivity, gluten-free food reducing the content of gluten has been recently received as healthy food. However, because the pizza dough has a high proportion of wheat flour, it requires an effort to reduce the content of gluten.

In order to solve the above problems, pizza dough and a manufacturing method thereof, which can nourish the pizza dough and help a digestive process, are conventionally proposed. Korean Patent No. 1635387 discloses functional well-being pizza dough, which is improved in taste and quality by using lactic acid bacteria fermentation, and a manufacturing method thereof. The functional well-being pizza dough is improved in taste and quality by adding a natural pine bark fermentation liquid and a polyphenol compound thereof in addition to lactic acid bacteria. Besides the above, a lot of patent cases propose methods for improving taste and quality by adding various materials to pizza dough.

Meanwhile, Korean Patent No. 0866772 granted to the inventor of the present invention discloses “functional well-being pizza dough, a manufacturing method thereof, and pizza”, wherein the functional well-being pizza dough is prepared by mixing wheat flour, soybean oil, refined sugar, grain-nut powder, refined salt, whey powder, instant yeast, chlorella powder, and green tea powder to provide sufficient nutrients, adding fiber to help digestion, and adding green tea to enhance the esthetic sense of dough. Korean Patent No. 0866772 granted to the inventor of the present invention can increase taste and quality of pizza and replenish nutrients. However, recently, necessity of pizza dough and pizza capable of coping with consumers' demands changed according to the change of time increases.

Recently, interest in food using natural materials is on the rise, a demand of food which is very digestible and helps the digestion process increases due to a change in food culture and dietary life. In accordance with a multi-change of personal taste, people prefer food having unique taste, such as sourness, bitterness, and others, and unique texture having the fun of chewing rather than food having simple sweet taste. Therefore, studies on pizza dough which is rich in fiber, has unique taste, such as sourness or bitterness, unique texture, and a visually esthetic sense are required.

### SUMMARY OF THE INVENTION

Accordingly, the present invention has been made to solve the above-mentioned problems occurring in the prior arts, and it is an object of the present invention to provide pizza dough and pizza which contain a large quantity of fibers by mixing green tea and various kinds of grains in pizza dough so as to evenly provide a number of nutrients necessary for physical activities, to promote health.

It is another object of the present invention to provide functional well-being pizza dough, a manufacturing method thereof, and pizza, capable of evenly dispersing green tea powder by mixing sourdough and aging the mixture at low temperature, increasing the digestive rate, providing rich texture and sourness, and helping to maintain healthy body and mind.

To accomplish the above objects, according to the present invention, there is provided functional well-being pizza dough manufactured using dough mixed of 2,750 to 2,800 parts by weight of wheat flour, 1,300 to 1,400 parts by weight of water, 110 to 120 parts by weight of refined sugar, 70 to 80 parts by weight of soybean oil, 80 to 90 parts by weight of grain-nut mixture, 50 to 60 parts by weight of refined salt, 20 to 30 parts by weight of whey powder, 8 to 12 parts by weight of bread improver, 4 to 6 parts by weight of sourdough, 4 to 6 parts by weight of yeast, 2 to 4 parts by weight of chlorella powder, and 1 to 4 parts by weight of green tea powder.

Moreover, the sourdough is subdivided from sourdough starter that is prepared through the steps of: mixing 2,750 to 2,800 parts by weight of wheat flour, 1,300 to 1,400 parts by weight of water, 110 to 120 parts by weight of refined sugar, 70 to 80 parts by weight of soybean oil, 80 to 90 parts by weight of grain-nut mixture, 50 to 60 parts by weight of refined salt, 20 to 30 parts by weight of whey powder, 8 to 12 parts by weight of bread improver, 4 to 6 parts by weight of yeast, 2 to 4 parts by weight of chlorella powder, and 1 to 4 parts by weight of green tea powder; and fermenting the mixture at temperature of 7 to 8° C. for 48 hours.

Furthermore, the sourdough is prepared by dividing some of the dough and fermenting the divided dough at temperature of 7 to 8° C. for 48 hours.

Additionally, the grain-nut mixture is mixed of 35 to 45 parts by weight of wheat flour, 20 to 25 parts by weight of rye powder, 15 to 20 parts by weight of sunflower seeds, 5 to 8 parts by weight of barley malt powder, 5 to 8 parts by weight of refined sugar, 2 to 5 parts by weight of refined salt, 1 to 2 parts by weight of oat flakes, 1 to 2 parts by weight of rye flakes, 1 to 2 parts by weight of barley flake, 1 to 2 parts by weight of black sesame powder, 1 to 2 parts by weight of pumpkin seeds, 1 to 2 parts by weight of corn powder, 1 to 2 parts by weight of roasted sorghum powder, 1 to 2 parts by weight of roasted black rice powder, and 1 to 2 parts by weight of roasted glutinous millet powder.

In addition, the green tea powder is manufactured through the steps of: harvesting leaves from green tea trees; filtering and sorting the green tea leaves with a net of 100 to 150 mm; roasting the sorted green tea leaves at temperature of 120 to 160° C. five times for ten minutes;

rubbing the roasted green tea leaves for 10 to 30 minutes; rapidly drying the green tea leaves by hot wind; aging the green tea leaves at temperature of 5° C. for 48 hours; and finely pulverizing the aged green tea leaves.

Moreover, the dough is manufactured through the steps of: adding and mixing half of the water to mixture of the grain-nut mixture, yeast, chlorella powder, and green tea powder to prepare mixed solution; mixing and dispersing the other half of the water to mixture of wheat flour, refined sugar, soybean oil, refined salt, whey powder, bread improver, and sourdough, and adding and mixing the mixed solution to prepare mixed material; subdividing the mixed material into a fixed quantity to prepare divided material; and putting the divided material in a low-temperature aging machine and aging the divided material at temperature ranging from −3° C. to 5° C. for 30 minutes to 120 minutes.

Furthermore, in another aspect of the present invention, there is provided functional well-being pizza manufactured using the pizza dough according to any one among claims 1 to 6.

According to the present invention, the following effects can be expected.

1. The pizza dough can prevent excessive expansion of pizza dough since sourdough is mixed to improve fermentability, increase freshness and digestibility, and provide unique flavor by having sourness.

2.Because sourdough subdivided from the sourdough starter in which green tea and grains are mixed and fermented is used, green tea and grains are evenly mixed in the pizza dough and can conserve their scents, the flavor of pizza dough is increased, and the color of green tea is expressed clearly and uniformly so as to increase the esthetic sense.

3. Because agglomeration of wheat flour is prevented through the low-temperature aging process of pizza dough, bad smell of wheat flour is removed, the flavor is improved, the color of the pizza dough is expressed uniformly and stably.

4. Because sourdough is substituted for lots of yeast during the aging step, it can reduce use of yeast, and provides rich fermented scent.

5. Because the grain-nut mixture contains rye which is adjusted in milling rate of husks, the dough can promote intestinal digestion by increasing the content of dietary fiber, reduce the content of gluten of the pizza dough by partially substituting wheat flour, and provide differentiated flavor and texture by adding the flavor and texture of grains.

6. The dough is mixed well with other materials and promotes fermentation by using green tea powder manufactured through sorting and processing steps, and provides good texture by dispersing the materials evenly. The present invention can provide dough from which the bitter taste of green tea is removed.

7. Because the pizza dough is aged at low temperature and is refrigerated to be distributed after being packed, the present invention can reduce cooking time of pizza, maintain freshness of pizza dough, and make dough soft.

8. Because various kinds of grains and nuts are added to the pizza dough, the present invention contains lots of fiber, provide enough nutrients, and improves health by selecting mixing materials effective to the human body.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a mimetic diagram illustrating a manufacturing process of sourdough according to an embodiment of the present invention.

FIG. 2 is a flow chart illustrating a manufacturing process of pizza dough according to an embodiment of the present invention.

FIG. 3 is a photograph illustrating a fermentation test.

FIG. 4 is a graph illustrating the experimental results of Table 1.

FIG. 5 is a graph illustrating the experimental results of Table 2.

FIG. 6 is a graph illustrating the experimental results of Table 3.

### DETAILED DESCRIPTION OF THE PREFERRED EMBODIMENT

Hereinafter, a preferred embodiment of the present invention will be described in detail with reference to the accompanying drawings.

1. Pizza Dough

The pizza dough according to a preferred embodiment of the present invention consists of mixed composition of wheat flour, water, refined sugar, soybean oil, grain-nut mixture, refined salt, whey powder, bread improver, sourdough, yeast, chlorella powder, and green tea powder.

The mixed composition mixed of 2,750 to 2,800 parts by weight of wheat flour, 1,300 to 1,400 parts by weight of water, 110 to 120 parts by weight of refined sugar, 70 to 80 parts by weight of soybean oil, 80 to 90 parts by weight of grain-nut mixture, 50 to 60 parts by weight of refined salt, 20 to 30 parts by weight of whey powder, 8 to 12 parts by weight of bread improver, 4 to 6 parts by weight of sourdough, 4 to 6 parts by weight of yeast, 2 to 4 parts by weight of chlorella powder, and 1 to 4 parts by weight of green tea powder.

The flour is baking wheat flour for the state of kneading of pizza dough as a basic material for pizza dough.

The water is used to mix the powder materials and enables the mixture to be aggregated into a lump. Especially, the pizza dough of the present invention is formed by mixing materials having various densities and volumes, such as grains, nuts, sourdough, chlorella powder, and green tea powder, and thus it is preferable to add 1,300 to 1,400 parts by weight of water based on 2,750 to 2,800 parts by weight of wheat flour in order to increase fluidity of the dough.

The refined sugar provides a sweet taste as a sugar ingredient.

The soybean oil which is a liquid material softens the dough to improve dough workability and texture, provides delicate flavor, and contains fatty acids called vitamin F necessary for the human body.

The grain-nut mixture is added to the pizza dough for a nutty taste, and rich flavor and a crispy texture of grains and nuts, is made by combination of grains and nuts, such as wheat flour, rye flour, sunflower seed, barley malt powder, refined sugar, refined salt, oat flakes, rye flakes, barley flakes, black sesame powder, pumpkin seeds, corn powder, roasted sorghum powder, roasted black rice powder, and roasted glutinous millet powder, and has a composition rate of 80 to 90 parts by weight with respect to 2,750 to 2,800 parts by weight of wheat flour of the dough.

The grain-nut mixture is made at a mixture rate of 35 to 45 parts by weight of wheat flour, 20 to 25 parts by weight of rye powder, 15 to 20 parts by weight of sunflower seeds, 5 to 8 parts by weight of barley malt powder, 5 to 8 parts by weight of refined sugar, 2 to 5 parts by weight of refined salt, 1 to 2 parts by weight of oat flakes, 1 to 2 parts by weight of rye flakes, 1 to 2 parts by weight of barley flake, 1 to 2 parts by weight of black sesame powder, 1 to 2 parts by weight of pumpkin seeds, 1 to 2 parts by weight of corn powder, 1 to 2 parts by weight of roasted sorghum powder, 1 to 2 parts by weight of roasted black rice powder, and 1 to 2 parts by weight of roasted glutinous millet powder.

Preferably, wheat flour mixed with the grain-nut mixture is strong flour. The strong flour is coarser in particles than medium flour or weak flour so as to provide crispy and rough texture of the pizza dough when being mixed with seeds and flakes.

The grain-nut mixture is made in the range of the above mixture rate, is prepared to be delivered after being mixed sufficiently and seal-packed, and can be mixed and used together with other pizza dough or bread on the spot after the packing is removed without additional composition process. In order to provide constant texture and taste, the grain-nut mixture can be mixed with flour, refined sugar, and refined salt. According to the dough of claim 1, wheat flour, refined sugar, and refined salt are mixed together with the grain-nut mixture.

Additionally, a small amount of flour, refined sugar, and refined salt are evenly mixed even when the grain-nut mixture is mixed and composed. The grain-nut mixture is stored, and then, is used in dough, so that the grain-nut mixture has salty and sweet taste since flour, refined sugar, and refined salt are uniformly coated on the seeds and flakes of grains and nuts.

The rye powder contained in the grain-nut mixture is a material which contains a large amount of fiber and reinforces the nutrition, and particularly, removes heat and quenches thirst.

In particular, the rye powder is powder which is formed by rye crushed and pulverized at milling rate of 75% to 85%, and unpolished husks are pulverized and are contained in the rye powder. Therefore, the rye powder contains lots of dietary fiber contained in the rye husks to promote intestinal digestion. However, a high content of dietary fiber tends to increase coarse and rough texture, but if rye polished at milling rate of 75% to 85% is pulverized, it relieves the coarse texture caused by the dietary fiber and increases chewy texture so as to provide rich texture. Therefore, in order to relieve the coarse texture, provide rich texture, and secure enough dietary fiber, it is preferable to pulverize rye polished at milling rate of 75% to 85%.

Furthermore, the rye powder can reduce the content of gluten contained in the pizza dough since being usable as a substitute of wheat flour. The gluten content of the rye powder is about 25% compared to the gluten content of wheat flour with the same weight, so that the gluten content of the whole pizza dough is lowered by using the rye powder as a partial substitute for wheat flour.

Therefore, the pizza dough according to the embodiment of the present invention increases moisture retention due to the low content of gluten, thereby alleviating drying and aging due to starch tissues of gluten as time goes by, and reducing the probability of occurrence of allergic or hypersensitivity symptoms caused by gluten during intake.

In addition, the present invention can perform a low-temperature long-term aging process to age the rye powder at temperature of 5° C. for 24 hours after pulverizing the rye powder. When the rye powder is aged at temperature of 5° C., natural lactic acid bacteria starts fermentation in an optimal state. The rye powder fermented by the fermentation action of the natural lactic acid bacteria has sour flavor. The sour flavor of the aged rye has a delicate and deep flavor different from the flavor of vinegar, thereby adding deep flavor to the pizza dough in which the aged rye powder is mixed. As described above, the lactic acid bacteria generated by the low-temperature fermentation can promote intestinal digestive power and prevent the proliferation of harmful bacteria in the intestine, thereby helping persons, who have a weak digestion or are difficult to digest flour-based food, to enjoy the flour-based food without burdens.

Therefore, it is preferable to use the rye powder polished at milling rate of 75% to 85% and aged at temperature of 5° C. for 24 hours.

Millet among the grain-nut mixture is alkaline food containing a large amount of fiber to increase the digestive rate, and especially, to remove heat accumulated in the spleen-gastrointestinal digestive system.

The sunflower seeds among the grain-nut mixture contain minerals, such as potassium, calcium, and iron, and vitamin B complex which is easy to lose in the process of refining grains, are good for high blood pressure, hypersensitivity, and arteriosclerosis, help blood circulation, and normalize the liver function by helping absorption of nutrients.

Additionally, in order to add various nutrients, vitamins, fibers, and grain flavor, besides rye powder, millet, and sunflower seeds, barley malt powder, black sesame powder, pumpkin seeds, corn powder, roasted sorghum powder, roasted black rice powder, and glutinous millet powder, Additionally, oats, rye and barley may be processed into flakes and blended to add a chewy texture.

The refined salt is seasoning for adjusting the taste.

The whey powder has a low fat content, increases flavor of food, increases the retention force of moisture so as to increase shelf life of the food by slowing down denaturation of the food, helps the pizza dough to brown uniformly and reduces baking time by adjusting shrinkage of the dough during Baking and causing the Maillard reaction.

The bread improver improves the quality of dough during baking, reduces process and working time, provides nutrition to yeast since including glucose or carbohydrate and increases the volume of the dough.

In order to manufacture sourdough, a fermentation method using sourdough made by fermenting dough. The fermentation method includes the steps of: producing a sourdough starter by activating microorganisms embedded in the mixed solution of dough; using some of the dough and storing the remainder of the dough; and repeating the above steps, that is, the method is a method of using some of the sourdough by subdividing the sourdough and baking the remaining sourdough as pizza dough.

The initial sourdough according to the present invention is used for dough in which some of the dough starter is subdivided to be used as dough for the next kneading. When the dough is manufactured, in the case that some of the dough previously kneaded is used as sourdough, the ratio of microorganisms suitable for baking is increased due to a long aging period, and the action of enzymes secreted by the microorganisms makes flavor of the dough deep, improves the state of the dough, suppresses aging of the dough, and improves preservation of the dough. The enzymes contained in the dough previously kneaded is proliferated by receiving nutrition by the bread improver, and biological activities of the enzymes aged through the aging period of the former dough and the aging period of the latter dough are varied, so that the dough has deep taste and flavor.

The sourdough starter according to the present invention is prepared through the steps of: 2,750 to 2,800 parts by weight of wheat flour, 1,300 to 1,400 parts by weight of water, 110 to 120 parts by weight of refined sugar, 70 to 80 parts by weight of soybean oil, 80 to 90 parts by weight of grain-nut mixture, 50 to 60 parts by weight of refined salt, 20 to 30 parts by weight of whey powder, 8 to 12 parts by weight of bread improver, 4 to 6 parts by weight of sourdough, 4 to 6 parts by weight of yeast, 2 to 4 parts by weight of chlorella powder, and 1 to 4 parts by weight of green tea powder; and fermenting the mixture at temperature of 7 to 8° C. for 48 hours. The composition is made by excluding the sourdough from the composition of claim 1.

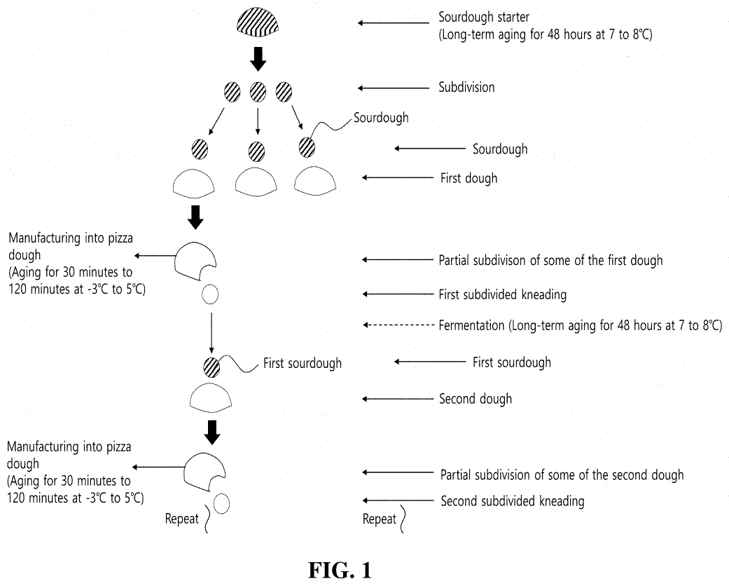

FIG. 1 illustrates a state in which some of the dough is used as sourdough for the next dough. Referring to FIG. 1, the manufacturing process of the sourdough using the dough will be described step by step as follows.

Hereinafter, sourdough which is initially manufactured is referred to as a ‘dough starter’, a dough kneaded next to the sourdough starter is referred to as a ‘first dough’, some of the first dough which is subdivided is referred to as a ‘first subdivided kneading’, the fermentation of the first subdivided kneading is referred to as ‘first sourdough’, and the fermentation of the first dough kneaded next is referred to as a ‘second dough’. Moreover, in order to facilitate understanding, a pattern treatment is performed on the dough made through the fermentation process in FIG. 1.

A method for manufacturing a dough starter comprises the steps of:

(A) manufacturing sourdough starter by mixing 2,750 to 2,800 parts by weight of wheat flour, 1,300 to 1,400 parts by weight of water, 110 to 120 parts by weight of refined sugar, 70 to 80 parts by weight of soybean oil, 80 to 90 parts by weight of grain-nut mixture, 50 to 60 parts by weight of refined salt, 20 to 30 parts by weight of whey powder, 8 to 12 parts by weight of bread improver, 4 to 6 parts by weight of sourdough, 4 to 6 parts by weight of yeast, 2 to 4 parts by weight of chlorella powder, and 1 to 4 parts by weight of green tea powder, and fermenting the mixture at temperature of 7 to 8° C. for 48 hours;

(B) subdividing the sour dough starter to prepare sourdough;

(C) mixing and kneading the sourdough in the composition of the step (A) to prepare a first dough;

(D) subdividing some of the first dough to prepare a first subdivided dough;

(E) fermenting the first subdivided kneading at temperature of 7 to 8° C. for 48 hours to prepare a first sourdough;

(F) mixing and kneading the first sourdough in the composition of the step (A) to prepare a second dough; and

(G) subdividing some of the second dough to prepare a second subdivided kneading.

As described above, the sourdough starter is prepared by mixing and kneading the composition of the step (A), and the first dough is prepared by mixing and kneading the sourdough subdivided from the sourdough starter to the composition of the step (A). From the next step after the first dough, sourdough which is subdivided and fermented from the previously kneaded dough is mixed to the current dough. In other words, when dough is manufactured according to an embodiment of the present invention, if the dough that sourdough subdivided from the initial sourdough starter is mixed and kneaded is referred to as the first dough, when the n^{th} dough is manufactured after the first dough, n^{-1st} sourdough subdivided from the n^{-1st} dough and fermented is mixed and kneaded.

The sourdough starter and the sourdough are aged at low temperature of 7 to 8° C. for 48 hours. When the dough is aged at low temperature of 7 to 8° C. for 48 hours, the growth of germs or bacteria belonging to the medium-temperature bacteria is suppressed, and fermentation is performed over a long time to increase the ligation of the dough. In addition, since the green tea powder mixed with the sourdough is mixed with the grain powder through low-temperature long-term aging, the bitter taste of green tea, strong flavor of flour, and grain flavor are alleviated to provide deep and soft taste, flavor, and color sense and to reinforce the nutty taste of grains.

The sourdough aged in the above process are improved in dispersion force so as to be uniformly mixed with the pizza dough, and has a smooth color by uniformly forming the unique color of the green tea.

The yeast is a granule state which is good at dispersion force so as to be directly mixed with wheat flour, provide uniform quality and strong fermentation force, provide good flavor, and provide stability when manufacturing pizza.

Chlorella contains complex nutritional supplements, such as ten times more chlorophyll than general vegetables, 8 essential amino acids required for the human body, various vitamins, and minerals, and also contains logs of chlorella growth factors (CGFs) which are biologically active materials helpful for health, contains a great deal of fiber, and has various effects of body quality improvement, weight control, body immunity strengthening, constipation relief, dioxin discharge, liver function improvement, blood pressure regulation, and the like. Moreover, chlorella expresses a clear green color on the pizza dough together with green tea powder. if the content of green tea powder is increased in order to clearly express green color on pizza dough, since the bitter taste of green tea may be increased, it is preferable to have 2 to 4 parts by weight of chlorella powder and 1 to 4 parts by weight of green tea powder based on 100 parts by weight of wheat flour. The pizza dough having the green color has a color differentiated from general pizza dough, and if pizza is made using the pizza dough, the color of the pizza dough is combined with the color of cheese and topping to increase the appetite.

The green tea contains catechin, a large amount of vitamin C, and a melanin pigment, and prevents obesity by reducing cholesterol and fat, helps to overcome fatigue, removes constipation, removes heavy metals in the body, prevents heart diseases, improves arteriosclerosis, and provides anticancer effects.

The green tea powder is manufactured through the steps of: harvesting leaves from green tea trees; filtering and sorting the green tea leaves with a net of 100 to 150 mm; roasting the sorted green tea leaves at temperature of 120 to 160° C. five times for ten minutes; rubbing the roasted green tea leaves for 10 to 30 minutes; rapidly drying the green tea leaves by hot wind; aging the green tea leaves at temperature of 5° C. for 48 hours; and pulverizing the aged green tea leaves.

The harvesting step is to gather green tea leaves from green tea trees. Differently from green tea leaves which is used to be drinkable as tea, the green tea leaves contained in the pizza dough is used to be edible. So, green tea leaves which has soft texture and has a little bitter taste must be used. Therefore, green tea leaves used for the green tea powder for the pizza dough are green tea leaves which are first harvested of a year. In more detail, it is preferable to collect young and soft leaves harvested from three-year-old green tea trees before Gogwoo, which is one of the 24 seasons by the lunar calendar. If grown green tea leaves are used, the hard texture of the leaves hurts the texture of food and makes the digestion action difficult.

The sorting step is a step of filtering the gathered green tea leaves with a net of 100 to 150 mm. A mesh net or a perforated plate sieve is used to sort small-sized green tea leaves among the young leaves. The small-sized green tea leaves are rich in vitamin C and nutrients, and provide soft texture. The maximum size of green tea leaves which are edible and soft ranges from 100 mm to 150 mm. Green tea leaves are sorted through the sorting step. Green tea leaves exceeding 100 mm to 150 mm is not suitable to be eaten due to tough fiber.

In the roasting step, the sorted green tea leaves are roasted at temperature of 120-160° C. for 10 minutes five times. In the roasting step, activation enzymes of green tea leaves are suppressed and moisture is removed so as to enhance storage quality. The roasting step is a step of removing the activation enzymes of green tea leaves in order to suppress fermentation of the green tea leaves and to uniformly ferment the green tea leaves together with the pizza dough. In order to completely remove the activation enzymes of green tea leaves, the green tea leaves are steamed in a steamer five times. The green tea powder after the roasting step is suppressed in fermentation before the aging step, and is prevented from generating bad smell or fermented scent so as to maintain constant quality.

The rubbing step is a step of rubbing the roasted green tea leaves for 10 to 30 minutes. The process of rubbing the green tea leaves like washing laundry makes the green tea leaves be dried easily and makes the green tea leaves soft by destroying cell membranes.

The drying step is a step of rapidly drying the green tea leaves by applying hot air to the green tea leaves. That is, in the drying step the green tea leaves are dried rapidly so that the content of moisture contained in green tea leaves is 4 to 5%.

The aging step is a step of aging the green tea leaves at temperature of 5° C. for 48 hours. Through the low-temperature long-term aging, the green tea leaves have a clear color, and have soft taste and good flavor since the bitter taste and flavor of the green tea leaves are relieved.

The pulverizing step is a step of finely pulverizing the aged green tea leaves.

Preferably, in the pulverizing step, the green tea leaves are pulverized finely into fine particles so that the green tea powder is mixed to the dough uniformly.

When the green tea powder manufactured through the above steps is added to the dough, the clear color of green tea is expressed, the bitter taste is alleviated to provide soft taste, and the green tea powder is evenly dispersed in the dough without agglomeration.

2. Manufacturing Method

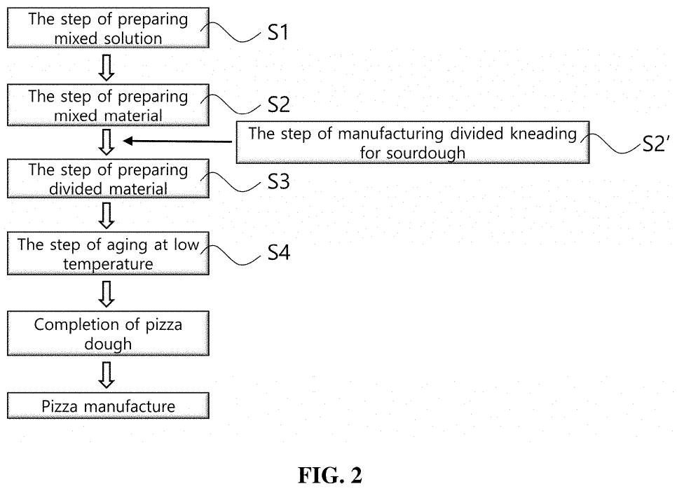

FIG. 1 illustrates a process of manufacturing n^{th} dough including, the first dough, the second dough, and so on, and FIG. 2 is a flow chart illustrating a pizza dough manufacturing process according to an embodiment of the present invention.

Referring to FIG. 2, the manufacturing method of pizza dough will be described. The manufacturing method of pizza dough includes a mixed solution composition step (S1), a mixed material composition step (S2), a divided material composition step (S3), and a low-temperature aging step (S4).

In addition, FIG. 2 illustrates an embodiment of the present invention in which materials of the pizza dough composition are sequentially mixed according to steps.

In the mixed solution composition step (Si), half of the water is added and mixed to mixture in which 80 to 90 parts by weight of grain-nut mixture, 4 to 6 parts by weight of yeast, 2 to 4 parts by weight of chlorella powder, and 1 to 4 parts by weight of green tea powder are mixed. In this instance, 650 to 700 parts by weight of water, which is 50% of 1,300 to 1,400 parts by weight of water, is added and mixed to the mixed solution. The parts by weight is based on 2,750 to 2,800 parts by weight of wheat flour as described above.

In the mixing material composition step (S2), the other half of the water is mixed and dispersed to mixture in which 2,750 to 2,800 parts by weight of wheat flour, 110 to 120 parts by weight of refined sugar, 70 to 80 parts by weight of soybean oil, 50 to 60 parts by weight of refined salt, 20 to 30 parts by weight of whey powder, 8 to 12 parts by weight of bread improver, and 4 to 6 parts by weight of sourdough are mixed. After that, the mixed solution is added to the mixture to prepare the mixed material. In this instance, 650 to 600 parts by weight of water, which is the remaining 50% of water, is added to mix and knead the mixed solution.

The configuration of the mixed solution and the mixed material is the same as described above, and thus, description thereof will be omitted.

In the divided material composition step (S3), the mixed material is subdivided into a fixed amount to prepare divided materials. In this instance, the manufacturing method further includes a subdivided dough manufacturing step (S2′) for sourdough in which some of the mixed material is subdivided before subdivision of the mixed material so as to prepare n^{th} subdivided dough illustrated in FIG. 1.

The process of subdividing some of the dough to prepare n^{th} subdivided dough and aging the n^{th} subdivided dough to prepare nth sourdough has described above, and so, the description will be omitted.

In the low-temperature aging step (S4), the divided material is put in a low-temperature aging machine and is aged at temperature ranging from −3° C. to 5° C. for 30 minutes to 120 minutes. In this instance, the mixed material is subdivided by 300 g to 600 g and the subdivided materials are arranged at regular intervals in the low-temperature aging machine, and then, are aged.

The kneading materials aged through the low-temperature aging step (S4) are individually packed and put in boxes to be delivered. The packed dough can be used to make pizza dough by baking work after the packing is removed, thereby improving workability.

According to the manufacturing method of dough, the grain-nut mixture with relative high density and mass, and yeast, chlorella powder, and green tea powder which must be uniformly dispersed to dough are first mixed with water to prepare the mixed solution, and then are added to other mixture in which the remaining materials are mixed in a liquid state, so that the grain-nut mixture, yeast, chlorella powder, and green tea powder are dispersed more uniformly to the dough.

Therefore, the sourdough aged at low temperature of 7 to 8° C. for 48 hours is uniformly mixed to the dough, and the dough is subdivided, and is aged at temperature of −3 to 5° C. for 30 minutes to 120 minutes so that enzymes of the sourdough act stably at low temperature to produce ingredients, such as amino acid. Accordingly, when pizza dough is manufactured using the dough, the pizza dough has deep flavor, improves moisture retention, and provides soft and chewy texture. Furthermore, the dough delays aging of the pizza dough to maintain freshness for a long time.

Additionally, the present invention can provide functional well-being pizza manufactured using the pizza dough made by the composition and the manufacturing method.

2. Test

(1) Fermentation Test

A difference in fermentation level between the case in which the sourdough according to the present invention was used (Embodiment 1) and the case in which the sourdough according to the present invention was not used (Comparative Example 1) was measured as time went by.

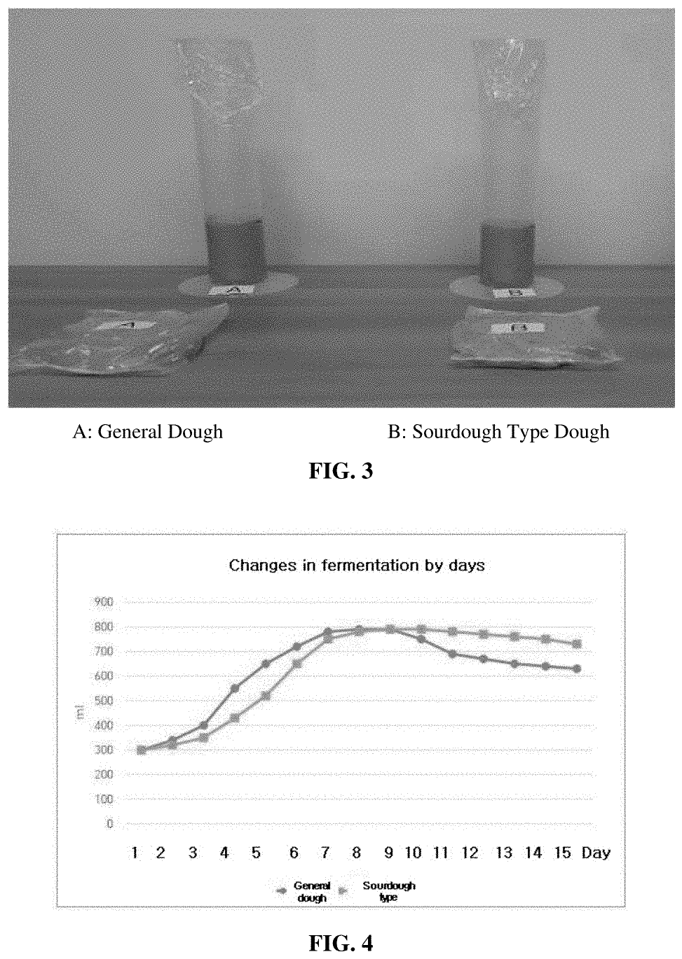

As shown in FIG. 3, in order to perform the fermentation test, in the embodiment 1 and the comparative example 1, the same amount of yeast was added, the dough according to the embodiment 1 and the dough according to the comparative example 1 were respectively put in measuring cylinders, and changes in volume of the doughs at the same temperature (10° C.) were measured as time went by.

TABLE 1

| | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| Division | day | day | day | day | day | day | day | day | day | day | day | day | day | day | day |
| General | 300 | 340 | 400 | 550 | 650 | 720 | 780 | 790 | 790 | 750 | 690 | 670 | 650 | 640 | 630 |
| dough | | | | | | | | | | | | | | | |
| Sourdough | 300 | 320 | 350 | 430 | 520 | 650 | 750 | 780 | 790 | 790 | 780 | 770 | 760 | 750 | 730 |
| type | | | | | | | | | | | | | | | |
| dough | | | | | | | | | | | | | | | |

(Unit: ML)

As seen in FIG. 4, which shows the table 1 and the data thereof into a graph, the date having the highest fermentation power was day 9 in case of the sourdough type dough and was day 8 in case of the general dough. It was confirmed that the general dough was rapidly reduced in fermentation power after reaching the highest point compared with the sourdough type dough.

As can be seen from the results of Table 1 above, the general dough rapidly increased the initial fermentation power but rapidly lowered the fermentation force after reaching the highest point. However, the sourdough type dough slowly reached the highest point in comparison with the general dough, slowly lowered in the fermentation power while maintaining the highest point longer. That is, it was confirmed that the sourdough type dough maintained fermentation power at the highest point than the general dough. Therefore, the sourdough type dough is more suitable for the present invention in which the sourdough is mixed to the next kneaded dough and is fermented.

(2) Sensory Evaluation

As shown in the following table, sensory evaluation was performed to pizza dough in the case that the optimally composed sourdough was used (Embodiment 2) and pizza dough in the case that the optimally composed sourdough was not used (Comparative Example 2).

The sensory evaluation comprehensively evaluated the flavor, color, texture, softness, and overall taste of pizza dough over 30 pizza dough experts in the same field, and performed using a preference test of 5-point measure for five items, and the result was expressed as an average value for each score.

TABLE 2

| Division | Flavor | Color | Texture | Softness | Taste |
|---|---|---|---|---|---|
| General dough | 4.2 | 4.4 | 4.5 | 4.3 | 4.4 |
| Sourdough type dough | 4.8 | 4.5 | 4.6 | 4.7 | 4.7 |

(5-Point: Very Good, 4-Point: Good, 3-Point: Normal, 2-Point: Bad, 1-Point: Very Bad)

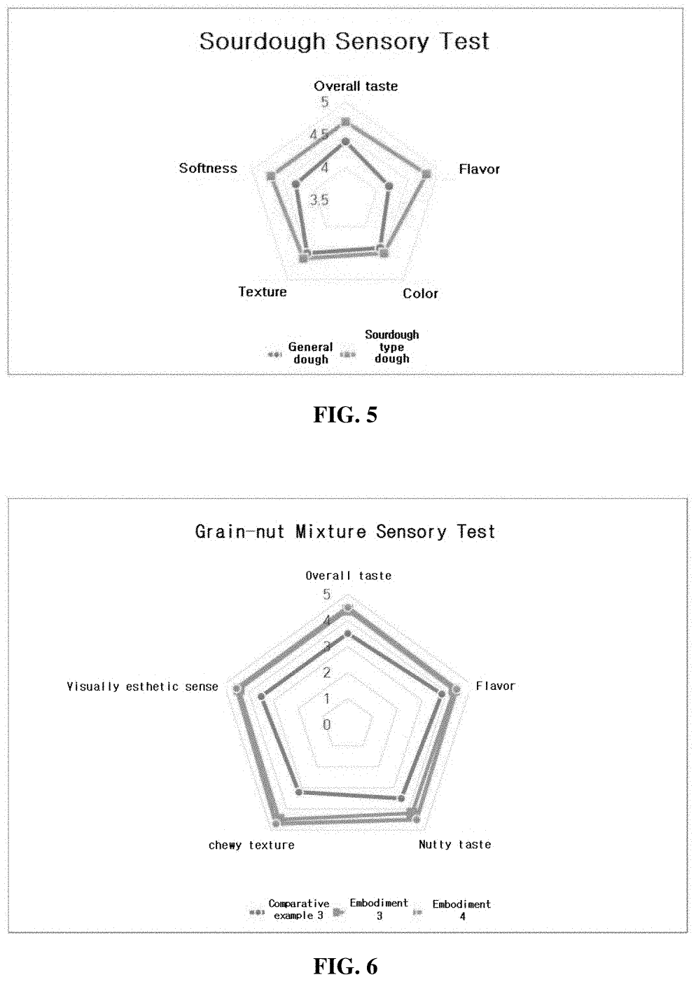

As seen in FIG. 5, which shows the table 2 into a graph, it was confirmed that the pizza dough to which sourdough was mixed was excellent in flavor, color, texture, softness, and taste, and especially, was improved in flavor and softness.

(3) Sensory Evaluation According to Use of Grain-Nut Mixture

A sensory evaluation to compare a pizza dough (Example 3) prepared by mixing grain-nut mixture containing rye with a milling rate of 100%, a pizza dough (Example 4) prepared by mixing grain-nut mixture containing rye with a milling rate of 80%, and a pizza dough (Comparative Example 3) prepared without mixing grain-nut mixture was performed.

The sensory evaluation was performed over 30 pizza dough experts in the same field using a preference test of 5-point measure for five items of flavor of pizza dough, nutty taste, chewy texture, visually esthetic sense, and overall taste, and the result was expressed as an average value for each score.

TABLE 3

| | | | | Visually | |
|---|---|---|---|---|---|
| | | Nutty | Chewy | esthetic | Overall |
| Division | Flavor | taste | texture | sense | taste |
| Comparative Example 3 | 3.8 | 3.5 | 3.2 | 3.5 | 3.5 |
| Embodiment 3 | 4.3 | 4.2 | 4.5 | 4.4 | 4.4 |
| Embodiment 4 | 4.4 | 4.5 | 4.7 | 4.5 | 4.5 |

(5-Point: Very Good, 4-Point: Good, 3-Point: Normal, 2-Point: Bad, 1-Point: Very Bad)

As seen in FIG. 6, which shows the table 3 into a graph, it was confirmed that the pizza dough in which grain-nut mixture was mixed was excellent in all items of flavor of pizza dough, nutty taste, chewy texture, visually esthetic sense, and overall taste, and was very improved in the chewy texture and the nutty taste. According to the present invention, powder of various grains having different flavors and tastes, for instance, rye powder, barley malt powder, black sesame powder, corn powder, roasted sorghum powder, roasted black rice powder, and roasted glutinous millet powder, flakes of various grains, for instance, oat flakes, rye flakes, and barley flakes, and nuts, for instance, sunflower seeds and pumpkin seeds) were mixed so as to improve the nutty taste of grains and nuts and the chewy texture of flakes with large particles. Additionally, since wheat flour with rough particles, such as weak flour, were coated previously, the crispy texture was added by the coated flour particles during baking. Especially, in comparison of embodiments 3 and 4, the embodiments 3 and 4 did not have a great difference in flavor, visually aesthetic sense, and overall taste, but the embodiment 4 was greatly improved in the nutty taste and the chewy texture. So, it was confirmed that rye with the milling rate of 80% was more improved in the nutty taste and the chewy texture.

(4) Sensory Evaluation of Grain-Nut Mixture According to Milling Rate of Rye Powder

The sensory evaluation of Table 4 was performed over 30 pizza dough experts in the same field using a preference test of 5-point measure by unit of 10% with respect to the roughness of the rye powder according to the milling rate of rye, and the result was expressed as response personnel for each score.

TABLE 4

| | Score | | | | |
|---|---|---|---|---|---|
| Milling rate | 5 | 4 | 3 | 2 | 1 |
| 86~95% | 1 | 2 | 7 | 8 | 12 |
| 75~85% | 8 | 15 | 5 | 2 | 0 |
| 65~74% | 12 | 6 | 7 | 5 | 0 |
| 55~64% | 17 | 7 | 5 | 1 | 0 |

(5-point: no rough texture, 4-point: slightly rough, 3-point: normal, 2-point: rough, 1-point: very rough)

As can be seen in Table 4, it was confirmed that there was almost no rough texture and there was chewy texture to some degree at milling rate of 75 to 85%. Therefore, it was confirmed that the optimum milling rate to secure fiber and provide good texture was 75 to 85%. If the milling rate exceeds 85%, texture may be degraded due to the rough texture, and if the milling rate is less than 75%, it is difficult to secure sufficient fiber and chewy texture. So, it is preferable to use rye polished at milling rate of 75 to 85%.

While the functional well-being pizza dough and the manufacturing method thereof according to the present invention have been described with reference to specific embodiments, it will be understood by those of ordinary skill in the art that various changes and modifications may be made in the present invention without departing from the technical scope and idea of the present invention, and they belong to the present invention.

What is claimed is:

1. Functional well-being pizza dough manufactured using dough mixed of 2,750 to 2,800 parts by weight of wheat flour, 1,300 to 1,400 parts by weight of water, 110 to 120 parts by weight of refined sugar, 70 to 80 parts by weight of soybean oil, 80 to 90 parts by weight of grain-nut mixture, 50 to 60 parts by weight of refined salt, 20 to 30 parts by weight of whey powder, 8 to 12 parts by weight of bread improver, 4 to 6 parts by weight of sourdough, 4 to 6 parts by weight of yeast, 2 to 4 parts by weight of chlorella powder, and 1 to 4 parts by weight of green tea powder.

2. The functional well-being pizza dough according to claim 1, wherein the sourdough is subdivided from sourdough starter that is prepared through the steps of: mixing 2,750 to 2,800 parts by weight of wheat flour, 1,300 to 1,400 parts by weight of water, 110 to 120 parts by weight of refined sugar, 70 to 80 parts by weight of soybean oil, 80 to 90 parts by weight of grain-nut mixture, 50 to 60 parts by weight of refined salt, 20 to 30 parts by weight of whey powder, 8 to 12 parts by weight of bread improver, 4 to 6 parts by weight of yeast, 2 to 4 parts by weight of chlorella powder, and 1 to 4 parts by weight of green tea powder; and fermenting the mixture at temperature of 7 to 8° C. for 48 hours.

3. The functional well-being pizza dough according to claim 1, wherein the sourdough is prepared by dividing some of the dough and fermenting the divided dough at temperature of 7 to 8° C. for 48 hours.

4. The functional well-being pizza dough according to claim 1, wherein the grain-nut mixture is mixed of 35 to 45 parts by weight of wheat flour, 20 to 25 parts by weight of rye powder, 15 to 20 parts by weight of sunflower seeds, 5 to 8 parts by weight of barley malt powder, 5 to 8 parts by weight of refined sugar, 2 to 5 parts by weight of refined salt, 1 to 2 parts by weight of oat flakes, 1 to 2 parts by weight of rye flakes, 1 to 2 parts by weight of barley flake, 1 to 2 parts by weight of black sesame powder, 1 to 2 parts by weight of pumpkin seeds, 1 to 2 parts by weight of corn powder, 1 to 2 parts by weight of roasted sorghum powder, 1 to 2 parts by weight of roasted black rice powder, and 1 to 2 parts by weight of roasted glutinous millet powder.

5. The functional well-being pizza dough according to claim 1, wherein green tea powder is manufactured through the steps of:
harvesting leaves from green tea trees;
filtering and sorting the green tea leaves with a net of 100 to 150 mm;
roasting the sorted green tea leaves at temperature of 120 to 160° C. five times for ten minutes;
rubbing the roasted green tea leaves for 10 to 30 minutes;
rapidly drying the green tea leaves by hot wind;
aging the green tea leaves at temperature of 5° C. for 48 hours; and
finely pulverizing the aged green tea leaves.

6. The functional well-being pizza dough according to claim 1, wherein the dough is manufactured through the steps of:
adding and mixing half of the water to mixture of the grain-nut mixture, yeast, chlorella powder, and green tea powder to prepare mixed solution;
mixing and dispersing the other half of the water to mixture of wheat flour, refined sugar, soybean oil, refined salt, whey powder, bread improver, and sourdough, and adding and mixing the mixed solution to prepare mixed material;
subdividing the mixed material into a fixed quantity to prepare divided material; and
putting the divided material in a low-temperature aging machine and aging the divided material at temperature ranging from −3° C. to 5° C. for 30 minutes to 120 minutes.

7. Functional well-being pizza manufactured using the pizza dough according to claim 1.

8. Functional well-being pizza manufactured using the pizza dough according to claim 2.

9. Functional well-being pizza manufactured using the pizza dough according to claim 3.

10. Functional well-being pizza manufactured using the pizza dough according to claim 4.

11. Functional well-being pizza manufactured using the pizza dough according to claim 5.

12. Functional well-being pizza manufactured using the pizza dough according to claim 6.
